(19) United States
(12) Patent Application Publication
(10) Pub. No.: US 2001/0025921 A1
(43) Pub. Date: Oct. 4, 2001

(54) Digital measuring scanner

(76) Inventor: Martin Teske, Dueren (DE)

Correspondence Address: HICKMAN COLEMAN & HUGHES, LLP, P.O. BOX 52037, Palo Alto, CA, 94306, US

(21) Appl. No.: 09/746,121

(22) Filed: Dec. 20, 2000

(30) Foreign Application Priority Data
Dec. 20, 1999 (DE) 199 61 906.9

(51) Int. Cl. H01J 3/14; H01J 5/16

(52) U.S. Cl. 250/234

(57) ABSTRACT

A digital measuring scanner for scanning and plotting the distribution of a measured variable across a scanning pattern in a digital scanning tunnel microscope. The scanner includes a sensor for the measured variable that scans the scanning pattern line by line, a differentiating circuit connected to the output of the sensor, an ADC (analog to digital converter) connected to the output of the differentiating circuit, a computer for producing image signals connected to the output of the ADC and an output device for the image signals that is connected to the output of the computer. The computer is designed such that it can reconstruct absolute output values based on the digital differentiated measuring signal with the absolute output values corresponding to the values of the measured variable in the scanning points and that produces image signals based on these values.

The invention concerns a digital measuring scanner for scanning and plotting the distribution of a measured variable across a scanning pattern and in particular a digital scanning tunnel microscope.

First, the object that the invention addresses is explained in more detail by way of an example of a known digital scanning tunnel microscope. A scanning tunnel microscope makes it possible to determine the elevation profile of a sample surface with an accuracy that exceeds 0.01 nm and thus is clearly below atom size. The known digital scanning tunnel microscope is equipped with a scan tip that is as pointed as possible and in most cases is made of tungsten. This scan tip is guided line by line across the sample surface by means of a piezoelectric actuator. In doing so, the tip of the scan tip is kept closely above the sample surface. Electrons are able to bridge this distance due to the tunnel effect. The scan tip guides the resulting tunnel current via a current amplifier to a PID controller. The controlled output of the PID controller is connected to a piezoelectric element that is responsible for changing the distance between the scan tip and the sample surface and also is attached to the actuator. The electrical voltage that is applied to the piezoelectric element via this controlled output is controlled in a manner that ensures that the tunnel current is constant. The voltage therefore is a measuring signal that represents the desired measured variable, i.e. the height of the sample surface. In more general terms, the scan tip together with the piezoelectric actuator and the PID controller present the sensor for the measured variable (in this case the height of the sample surface) that scans the scanning pattern line by line (in this case the sample surface).

The measuring signal, in this case the voltage that the PID controller applies to the piezoelectric element, is an analog signal. In the known digital scanning tunnel microscope the output of the PID controller is connected to an analog-to-digital converter (ADC) that converts the analog measuring signal to a digital measuring signal. The digital measuring signal is forwarded to a computer in which the data contained in the signal are processed for evaluation and plotting purposes. For example, the computer contains a program that stores data from a preset number of adjacent scanning lines and based on these data produces image signals that are output on a screen. The image shown on the screen represents the elevation profile of the sample surface in the form of a contour line diagram, i.e. each gray or brightness level of a pixel is assigned a certain elevation value or a certain elevation value interval. This makes it possible, based on the brightness value of a pixel, to conclude the height of the sample surface in the position of the scanning pattern that corresponds to this pixel.

One disadvantage of this known digital scanning tunnel microscope is that the ADC must provide a very high level of resolution, as is explained in more detail in the following example.

The surface of a gold crystal is to be plotted. Since the crystal surface has many mono-atomic steps with a step height of approx. 0.23 nm, the image information will be mainly comprised of the steps. However, above all the fine structures with a structure height of approx. 0.01 nm on the terraces (atom layers) of the individual steps are of special interest, which requires an enormous resolution capability. If, for example, 100 terraces are stacked in the section of the crystal surface that is to be scanned (scanning pattern), this corresponds to an overall height of 23 nm, if the individual steps are 0,23 nm high. In order to be able to plot the atomic fine structure with a sufficient degree of accuracy, at least ten elevation values should be available for the structure height of approx. 0.01 nm. This means that the elevation resolution is 0.001 nm (=0.01 nm/10) so that 23,000 elevation values (=100×0.23 nm×10/0.01 nm) are needed for plotting 100 terraces. The ADC therefore must provide a resolution of 15 bit (allows for 2¹⁵=32,768 differentiable values) since only 16,384 values (=2¹⁴) can be differentiated with 14 bit. There are ADCs that offer such high levels of resolution, however, they are quite expensive.

Another problem is the fact that it is difficult to align the sample relative to the scan tip in a manner that ensures that the terraces of the crystal surface that are located in the area of the scanning pattern are at a right angle with regard to the direction of motion of the scan tip in which the tip is moved. This is necessary in order to maintain a constant level of tunnel current or a constant distance respectively.

If, for example, the sample surfaces are off by an angle of only 0.6° in the direction of a scanning line and thus are not oriented ideally anymore, the scan tip, based on

If, for example, the sample surfaces are off by an angle of only 0.6° in the direction of a scanning line and thus are not oriented ideally anymore, the scan tip, based on this tilt angle, must be lifted by approx. 1 nm (=100 nm×tan 0.6°) with a line length of 100 nm while it is moved from the beginning to the end of the scanning line. With a resolution of 0.001 nm as mentioned above, this change in elevation of 1 nm already corresponds to 1,000 elevation values although only one signal elevation value would be required with ideal orientation of the sample surface (tilt angle of 0°). Consequently, many more than the above calculated 23,000 elevation values would be necessary so that the resolution of the ADC must be correspondingly higher.

The object of the invention therefore is to make available a digital measuring scanner for scanning and plotting the distribution of a measured variable across a scanning pattern and in particular a digital scanning tunnel microscope that allows for the use of an ADC with a lower resolution.

The object is attained by means of a digital measuring scanner for scanning and plotting the distribution of a measured variable across a scanning pattern that contains:

a sensor for the measured variable that scans the scanning pattern line by line;

a differentiating circuit that is connected to the output of the sensor;

an ADC that is connected to the output of the differentiating circuit;

a computer for producing image signals that is connected to the output of the ADC and whose design is such that it can reconstruct absolute output values based on the digital differentiated measuring signal with the absolute output values corresponding to the values of the measured variables in the scanning points and that can produce image signals based on these values; and

an output device for the image signals that is connected to the output of the computer.

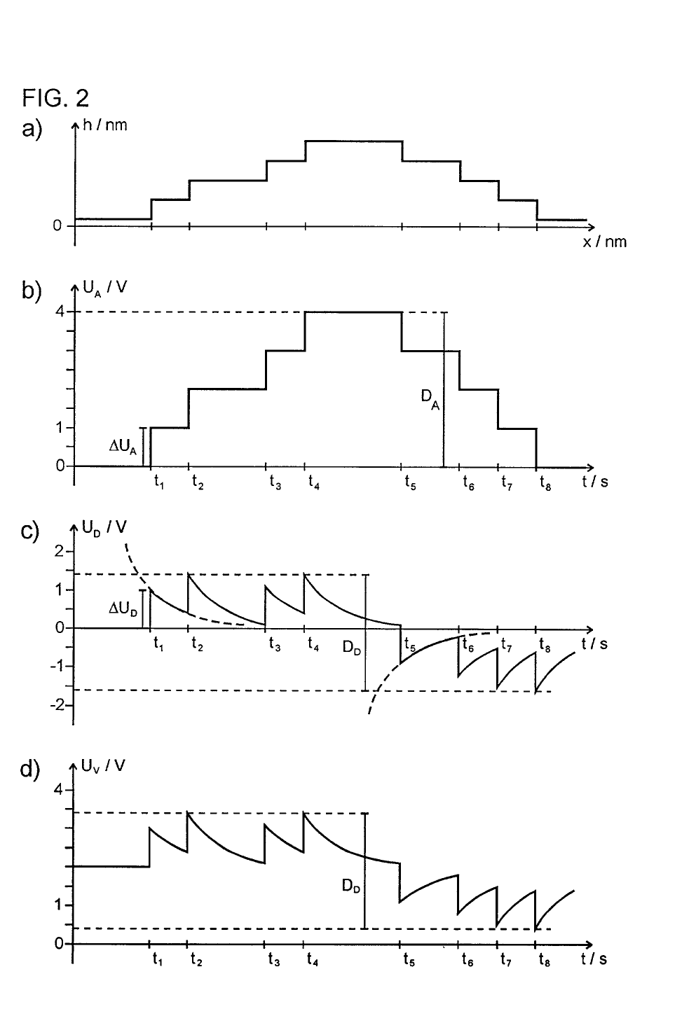

In this digital measuring scanner the analog measuring signal that is issued by the sensor and corresponds to the measured value is not forwarded directly to the ADC as has been customary up until now, but rather is forwarded via the inserted differentiating circuit. In the following paragraphs the output signal of the differentiating circuit is called differentiated measuring signal and in order to provide a differentiation the output signal of the sensor is called absolute measuring signal since this directly corresponds to the absolute or actual measured variable. The differentiating circuit strongly reduces the dynamic range of the measuring signal, i.e. the dynamic range of the differentiated measuring signal is smaller than that of the absolute measuring signal. In this case dynamic range is the difference between the maximum value and the minimum value of the measuring signal. This reduction of the dynamic range is explained in more detail in the following paragraphs using a simple example and is based on FIGS. 2a through 2c.

FIG. 2a shows a cross-section through a surface profile along a scanning line. The surface profile has five stacked terraces or atom layers so that there first are four ascending and then four descending steps along the scanning line from left to right.

FIG. 2b shows the time history of the absolute measuring signal U_{A} that corresponds to the surface profile of FIG. 2a along the scanning line. The first and bottom terrace is represented by measuring value U_{A}=0 V, the second, third and fourth terraces correspond to U_{A}=1 V, U_{A}=2 V or U_{A}=3 V, and the fifth and uppermost terrace corresponds to U_{A}=4 V. The dynamic range of the absolute measuring signal U_{A} therefor is D_{A} =4 V (=4 V−0 V).

FIG. 2c shows the time history of the differentiated measuring signal U_{D} that corresponds to the absolute measuring signal U_{A} of FIG. 2b and that is transferred from the output of the differentiating circuit to the ADC. Just as in FIG. 2b, the left part of the bottom terrace is represented by measuring value U_{D}=0 V. Since the absolute measuring value at time t₁ jumps by +ΔU_{A}=1 V to U_{A}=1 V which corresponds to the first increasing step (ascending step), the differentiated measuring signal also jumps by +ΔU_{D} to U_{D}=1 V at time t₁. We selected ΔU_{D}=ΔU_{A}=1 V in this case in order to be able to compare the two dynamic ranges in a simple manner.

In the case of the three remaining ascending steps to the third, fourth and fifth terrace (corresponding to times t₂, t₃, and t₄), the differentiated measuring signal U_{D} jumps by +ΔU_{D} each in response to the jumps of the absolute measuring signal U_{A} by +ΔU_{A} each. However, after each jump the differentiated measuring signal U_{D} decreases in accordance with the real characteristic of the differentiating circuit in the direction of the 0 V line, since the absolute measuring signal U_{A} remains constant in time intervals t₁<t<t₂, t₂<t<t₃, t₃<t<t₄, and t₄<t<t₅ that correspond to the second, third, fourth and fifth terrace. Consequently the differentiated measuring signal U_{D} does not base its upward jumps on the level of the previous jump at the beginning of the respective terrace but rather on the lower level at the end of this respective terrace that is closer to the 0 V line based on the fading curve. Therefore it reaches its maximum at time t₄ at a relatively low value (here: U_{Dmax}≈1,4 V) although it jumps by +ΔU_{D}=1 V with each ascending step just like the absolute measuring signal U_{A} while the absolute measuring signal U_{A} does not reach its maximum at time t₅ until U_{Amax}=4 V so that U_{Dmax}<U_{Amax} applies.

For the dropping steps (descending steps) corresponding to times t₅, t₆, t₇, and t₈ the response behavior of the differentiated measuring signal U_{D} is unchanged, I.e. initially it jumps by −ΔU_{D} just like the absolute measuring signal U_{A} that jumps by −ΔU_{A} each at these times, but then fades towards the 0 V line. Although the differentiated measuring signal U_{D} reaches its minimum at time t₈ at U_{Dmin}≈−1.6 V only, but the absolute measuring signal U_{A} reaches its minimum at time t₈ already at U_{Amin}=0 V, the dynamic range of the differentiated measuring signal D_{D}=U_{D-max}−U_{Dmin}≈3.0 V is clearly smaller than that of the absolute measuring signal with D_{A}=U_{Amax}−U_{Amin}=4 V. This difference increases with the number of additional adjacent steps in the same direction and the larger the distance between two adjacent steps in the same direction and the steeper the fade behavior of the differentiating circuit.

The differentiated measuring signal U_{D} is supplied to the ADC which in turn converts it to the digital file format. This digital signal then is supplied to the computer which reconstructs absolute output values based on these values which correspond to the elevation values of the scanned surface profile. In order to facilitate the evaluation, the computer generates image signals based on these reconstructed absolute output values which then are supplied to the output device for plotting purposes. The reconstruction of the absolute output values by the computer takes the response behavior of the differentiating circuit into consideration. The required characteristic data required for this process could be determined experimentally or theoretically based on the structure of the differentiating circuit.

Advantageous characteristics and improvements of the invention are described in the sub-claims.

One preferred embodiment requires that the differentiating circuit have a capacitor and/or a coil. These preferably are connected in order to form a high pass filter that, in its most simple form can be a capacitor/resistor (CR element) or a RL element.

In addition, it is possible to place a device for signal matching between the differentiating circuit and the ADC with this device being such that it amplifies the differentiated signal by a pre-set factor and increases it by a pre-set signal level. This device for signal matching preferably is an operational amplifier. The signal matching is used for setting the contrast and the mean brightness of the image signals that can be set by selecting a suitable amplification factor and an increase factor.

Preferably the computer that is used for reconstructing the absolute output values carries out the following steps:

calculates a first intermediate value (Z₁(n,m)) for each scanning point by determining a mean value based on the values of the digital differentiated measuring signal S_{D} in the scanning points and by subtracting this mean value from the value in this scanning point;

calculates a second intermediate value (Z₂(n,m)) for each scanning point by applying the following formula in each line of the scanning pattern for the scanning point at the beginning of this respective line:

Z₂(1,m)=Z₁(1,m),

and by applying the following iteration formula for each additional scanning point of this line:

Z₂(n,m)=Z₂(n−1,m)+Z₁(n,m)−Z₁(n−1,m)×exp(−Δn/τ),

wherein: m is the index for the lines on the scanning pattern; n is the index for the scanning points in a line, and n=1 represents the beginning of the line; Z₂(n,m) is the second intermediate value to the n-th scanning point in the m-th line; Z₁(n,m) is the first intermediate value to the n-th scanning point in the m-th line; Δn is the index difference between two adjacent scanning points of a line and Δn=n−(n−1)=1 applies; and τ is a fading constant that represents the fading behavior of the differentiating circuit;

calculates a third intermediate value (Z₃(n,m)) for each scanning point by applying the following formula for the scanning points of the first line of the scanning pattern:

Z₃(n,1)=Z₂(n,1),

and initially calculates the difference (D(n,m)) in each additional line for the scanning points of this line based on the following formula:

D(n,m)=Z₂(n,m)−Z₂(n,m−1),

wherein: m is the index for the lines on the scanning pattern and m=1 represents the first line of the scanning pattern; n is the index for the scanning points in one line; Z₂(n,m) is the second intermediate value for the n-th scanning point of the m-th line and D(n,m) is the difference for the n-th scanning point of the m-th line,

then determines a mean value based on the differential values (D(n,m)) of this line and finally adds this mean value to each second intermediate value (Z₂(n,m)) in the scanning points of this line; and

calculates the absolute output value for each scanning point by selecting the minimum from all third intermediate values (Z₃(n,m)) and subtracts this minimum from the third intermediate value (Z₃(n,m)) at this scanning point.

In the first step in which the first intermediate value Z₁ is calculated, the mean value is determined in order to remove any interfering signals or photoelectric noise in the measuring signal. In addition, this mean value corresponds to the mean brightness of the digital differentiated measuring signal S_{D} that determines the zero line to which the fading curves in the differentiated measuring signal U_{D} refer. This mean brightness can be desired or deviate from the 0 V line due to the concrete circuitry of the components that influence the digital differentiated measuring signal (such as sensors, differentiating circuit, ADC or signal matching components) or can be undesired due to interference. Since, however, the reconstruction is easier from this point on when the fading curves refer to a zero line that is located at 0 V, the mean value is subtracted from each value of the digital differentiated measuring signal S_{D}. These first intermediate values Z₁ thus correspond to the differentiated measuring signal U_{D} at the output of the differentiating circuit.

In the second step the second intermediate values Z₂ are calculated from the first intermediate values Z₁ for each scanning line. The fading behavior of the differentiating circuit is described by means of an exponential function since it presents a good approximation in most cases. If the fading behavior deviates too strongly from an exponential course, the exponential function can be substituted with a different, for example a linear or parabolic, function that provides a better description of the fading behavior.

The described calculation of the second intermediate values Z₂ of each scanning line of the scanning pattern is based on the following thoughts. If one assumes that an analog measuring signal U_{A} is applied to the input of the differentiating circuit when scanning data, with the measuring signal being constant for the time period under consideration and producing the actual value Zᵢ(n,m) on the output of the differentiating circuit at the time that corresponds to the scanning point n of a certain line m with the actual value corresponding to the calculated first intermediate value Z₁(n,m), then one expects that the differentiated measuring signal U_{D} reaches the set value Zₛ(n+1,m)=Zᵢ(n,m)×exp(−Δnτ) at the time that corresponds to the next scanning point n+1 of this certain line m, and Δn=(n+1)−n=1 applies and τ is the fading constant that represents the fading behavior of the differentiating circuit. If, however, not the set value Zₛ(n+1,m) but rather the actual value Zᵢ(n+1,m) is reached at time n+1, it is possible to draw the conclusion that the analog measuring signal U_{A} must in fact have changed by value Zᵢ(n+1,m)−Zₛ(n+1,m). This means that this change must also apply to the other two reconstructed second intermediate values Z₂(n,m) and Z₂(n+1,m) under consideration. This results in the following equation:

Z₂(n+1,m)−Z₂(n,m)=Zᵢ(n+1,m)−Zₛ(n+1,m)

This results in the following iteration formula:

Z₂(n+1,m)=Z₂(n,m)+Zᵢ(n+1,m)−Zₛ(n+1,m)

=Z₂(n,m)+Zᵢ(n+1,m)−Zᵢ(n,m)×exp(−Δn/τ),

which corresponds to the described iterations formula when the calculated first intermediate value Z₁ (n,m) is assigned to the actual value Zᵢ(n,m) and when the index n is shifted by −1.

Since the reconstructed second intermediate value Z₂(1,m) cannot be determined with this iteration formula at the beginning of scanning line m, i.e. at the time that corresponds to the scanning point n=1 of line m, it initially is set to the first intermediate value Z₁(1,m) at the beginning of the scanning line.

In the third step Z₂(1,m), which has yet to be determined, is calculated. To this end a mean value is determined by comparing a line m with the respective previous line m−1 and then this mean value is added to the second intermediate values Z₂(n,m) of this line m and thus also to the second intermediate value Z₂(1,m) at the beginning of line m.

This mean value is determined based on a set of differential values D(n,m) at each scanning point n in a line m. Based on a good approximation it is possible to assume that in an original image most pixel values of two adjacent lines m and m−1 do not deviate or only deviate a little. Therefore the difference between the second intermediate values Z₂(n,m) and Z₂(n,m−1) of the two lines m and m−1 is formed in each scanning point n. Since there is no preceding line to the first scanning line m=1, it initially remains unchanged.

In the fourth step the first scanning line m=1 is corrected as well. To this end the minimum is selected from all third intermediate values Z₃ that are available after the third step and is subtracted from each of these third intermediate values Z₃, i.e. also from the third intermediate values Z₃(n,1) of the first scanning line m=1. Now the absolute output values are reconstructed that correspond to the values of the measured variable at the scanning points of the scanning pattern.

In the case of such a reconstruction the mean value that is determined in the first step based on the values of the digital differentiated measuring signal, preferably is determined by means of arithmetic averaging.

In the case of such a reconstruction the mean value that is determined in the third step based on the differential values D(n,m) of a line m, preferably is determined by means of arithmetic averaging or by averaging that is weighted by they frequency of the differential values D(n,m).

In the case of such a reconstruction the fading constant τ preferably can be input into the computer. Varying this input parameter can modify the reconstruction. For example, in the case of the scanning and plotting of a surface profile of a crystal, this input parameter can be varied until the terraces of the crystal surface are horizontal (based on the absolute output value) in the reconstructed image.

If, however, the differentiating circuit in such a reconstruction has a capacitor and a resistor, the computer also is able to calculate the fading constant τ by dividing the cycle duration of the ADC by the capacity of the capacitor and the value of resistance of the resistor.

In a preferred embodiment the output values are shown as a contour line diagram. In this case it is advantageous if the brightness and/or color of the corresponding pixels represent the output values in the contour line diagram.

The following paragraphs describe preferred exemplary embodiments of the invention by means of the attached drawings.

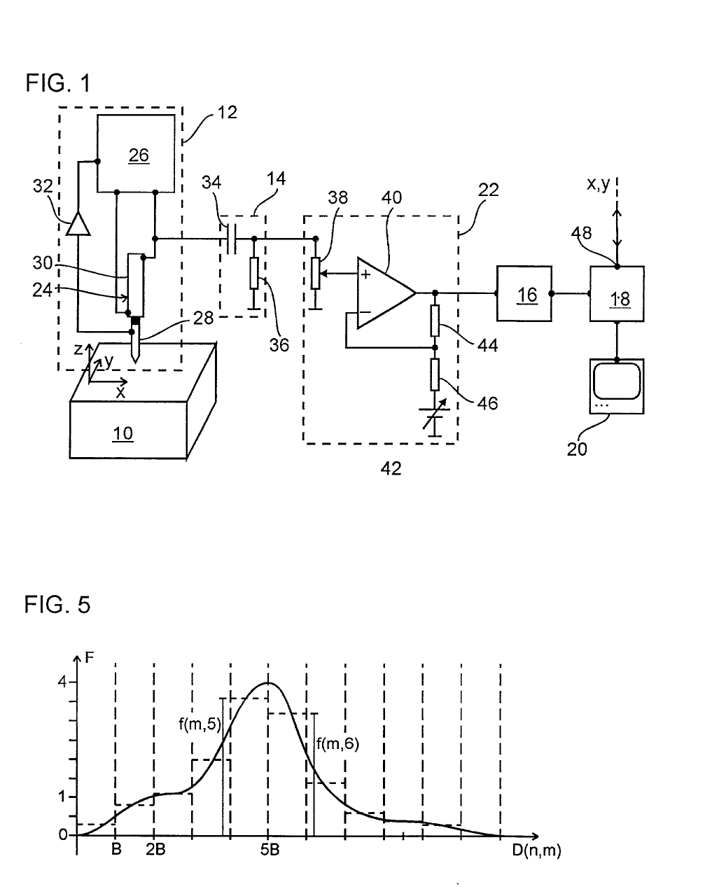

FIG. 1 is a circuit diagram that shows the basic structure of a digital scanning tunnel microscope that is an example of a digital measuring scanner for scanning and plotting the distribution of a measured variable across a scanning pattern in accordance with the invention;

FIG. 2a is a graph that shows a simplified elevation profile of a crystal surface along a scanning line;

FIG. 2b is a graph that shows a simplified time history of the absolute measuring signal that is applied to the output of the sensor of the microscope in FIG. 1 while it is guided along the scanning line of FIG. 2a and is supplied to the ADC in known digital scanning tunnel microscopes;

FIG. 2c is a graph that shows a simplified time history of the differentiated measuring signal that belongs to the absolute measuring signal of FIG. 2b that is applied to the output of the differentiating circuit of the microscope in FIG. 1 and is supplied to the ADC;

FIG. 2d is a graph that shows a simplified time history of the shifted and amplified measuring signal that belongs to the differentiated measuring signal of FIG. 2c that is applied to the output of the signal matching circuitry of the microscope of FIG. 1 via which it is supplied to the ADC by the differentiating circuit;

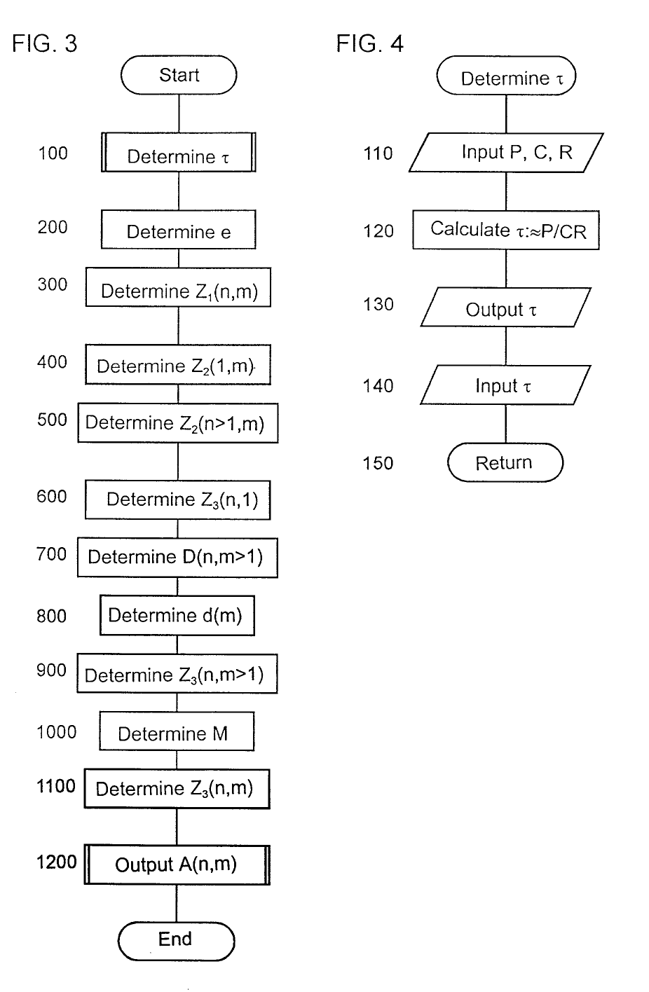

FIG. 3 is a program flowchart that shows an embodiment of the program that the computer performs and that is used for reconstructing the absolute output values from the digital differentiated measuring signal of FIG. 2d;

FIG. 4 is a program flowchart that shows an embodiment of a subroutine that is called up by the reconstruction program of FIG. 3 and that is used to determine the fading constant; and

FIG. 5 is a graph that shows a simplified frequency distribution of differential values between the scanning points of an exemplary scanning line and those of the previous scanning line.

FIG. 1 shows a schematic overall view of a digital scanning tunnel microscope that is used as an example for application for a digital measuring scanner in accordance with the invention.

However, the invention is not restricted to this application but rather also comprises other digital measuring scanners such as optical scanners that read in and digitalize graphic images including printed texts and images such as x-rays, in order to process them in computers.

The following paragraphs describe the structure and the function of the digital scanning tunnel microscope in FIG. 1 based on the determination of the elevation profile of a gold crystal 10. In this case the measured variable is height h (ref. FIG. 2a) of the crystal surface. In the case of an image scanner for x-rays the measured variable would be the blackening or the transmittance of the x-ray film, for example.

The microscope has a measuring sensor 12, a differentiating circuit 14, an ADC 16, a computer 18 and a screen 20. In addition, there is a signal matching circuitry 22 between the differentiating circuit 14 and the ADC 16 that is used for amplifying and shifting the differentiated measuring signal.

The measuring sensor 12 has a sensor 24, a x-y-piezoelectric actuator (not shown) for the sensor 24 and a PID controller for adjusting the height of the sensor 24 relative to the crystal surface in the direction of z.

The sensor 24 is comprised of a scan tip 28 made of tungsten and an actuator 30 made of piezoelectric material whose upper end is attached at the actuator parallel to the z axis and with the scan tip 28 being located at the lower end that points to the crystal surface. One of the poles of the controlled voltage output of the PID controller 26 is connected to the upper end and its opposite pole to the lower end of the actuator 30 so that a change in this electric voltage results in a change in length of the actuator 30 in the direction of z and consequently in a corresponding change of the distance of the scan tip 28 relative to the crystal surface. The scan tip 28 is insulated with regard to the actuator 30 and is connected to the input of the PID controller 26 by means of a current amplifier. The current amplifier 32 amplifies the current Iₜ from the scan tip 28 to approx. 1 nA. The direct current that is applied to the controlled output of the PID controller 26 ranges between −50 V to +50 V.

The input of the differentiating circuit 14 is connected to the controlled output of the PID controller 26 and comprises a capacitor 34 and a resistor 36 that are switched like a simple high pass filter.

The output of the differentiating circuit 14 is connected to the input of the ADC 16 by means of the signal matching circuitry 22. The optional signal matching circuitry 22 is used to adjust the output signal of the differentiating circuit 14 to the input of the subsequent ADC 16 as best as possible. This adjustment comprises the amplification of the signal level (corresponding to the change in contrast of an image signal) by means of a potentiometer 38 and the shift of the signal level (corresponding to the change of the brightness of an image signal) by means of an operational amplifier 40 and an adjustable voltage source 42. The potentiometer 38 connects the input of the signal matching circuitry 22, which is connected to the output of the differentiating circuit 14, with the ground and is connected to the non-inverted input of the operational amplifier 40 by means of its sliding-action contact. The output of the operational amplifier 40 also forms the output of the signal matching circuitry 22 and in addition is guided back to the inverted input of the operational amplifier 40 by means of a first resistor divider 44. In addition, this inverted input is grounded via a second resistor divider 46 and the adjustable voltage source 42.

The input of the ADC 16 is connected to the output of the signal matching circuitry 22 and its output is connected to the input of the computer 18. It converts the analog input signal U_{V} into a digital output signal S_{D} that the computer can read in. The computer 18 produces image signals B_{A} based on the digital measuring signal S_{D} that the ADC 16 provides, with these image signals showing the absolute elevation values of the crystal surface in the individual scanning points, which then are plotted on the screen 20.

In addition, the computer 18 is connected to the x-y-actuator via an interface 48 in order to control it. In order to now scan the elevation profile of the surface of the crystal 10, the computer 18 controls the x-y-actuator in a manner that ensures that it guides the measuring sensor 12, line by line, across the crystal surface section (scanning pattern) under consideration. The tip of the scan tip 28 is kept at a very small distance above the crystal surface so that electrons can bridge it due to the tunnel effect. The current amplifier 32 amplifies the resulting tunnel current It to approx. 1 nA and supplies it to the PID controller 26. The PID controller 26 controls the output voltage supplied to the piezoelectric actuator 30 in a manner that ensures that the tunnel current Iₜ remains constant. I.e. the controlled output voltage of the PID controller 26 represents the height h of the crystal surface along the scanning lines and therefore is called absolute measuring signal U_{A}.

In FIG. 1 the three coordination axis are aligned in a manner that ensures that the scanning lines run along the x-axis and are adjacent in the direction of the y-axis and that the lifting and lowering of the scan tip 28 by means of the actuator 30 for maintaining the distance above the crystal surface is along the z-axis.

If, for example, FIG. 2a represents height h of the crystal surface along one single scanning line, then FIG. 2b shows the time history of the absolute measuring signal U_{A} that belongs to this particular scanning line. Since the differentiating circuit 14 of FIG. 1 is a simple CR element, the differentiated measuring signal U_{D} that is applied to its output fades after each jump with the jump corresponding to the stages of the absolute measuring signal U_{A} at times t₁, t₂, . . . , t₈ with the fading being exponential in the direction of the 0 V line. FIG. 2c shows the time history of the differentiated measuring signal U_{D} at the output of the differentiating circuit 14 or on the input of the signal matching circuitry 22 respectively that belong to the scanning line under consideration.

Since the ADC 16 in FIG. 1 only can properly process those input signals whose voltage values range between 0 V and a certain positive maximum value, the potentiometer 38 and the adjustable voltage source 42 were set, before the measuring process, in a manner that ensures that the expected input signals, i.e. the differentiated measuring signals U_{D} on the output of the differentiating circuit 14, are amplified (or attenuated) and shifted in a manner that ensures that they fit into this input interval of the ADC. FIG. 2d shows the time history of the amplified and shifted differentiated measuring signal U_{V} on the output of the signal matching circuitry 22 or on the input of the ADC 16 respectively.

The ADC 16 converts the analog input signal U_{V} into a digital output signal S_{D} in which it determines the corresponding transient value of the input signal U_{V} at preset scanning times whose distance of time is [determined] by the synchronization of the ADC 16 in accordance with its synchronization period duration P.

In order to keep the following explanations as clear as possible, we assume that the analog input signal U_{V} of each scanning line is divided into 512 time intervals so that the digital output signal S_{D} is comprised of a total of 512 individual values for each scanning line and that are called differentiated input values E(n,m) with 1≦n≦512 in the subsequent paragraphs and in which n is the index for naming the individual scanning points in a scanning line. For illustration purposes we also assume that the scanning pattern is divided into a total of 512 scanning lines so that 1≦m≦512 applies.

The computer 18 saves the total of 262,144 (=512×512) input differentiated input values E(n,m) for further processing and uses them to reconstruct just as many absolute output values A(n,m) that correspond to the measured elevation values h(n,m) in the individual scanning points of the scanning pattern and converts them into image signals B_{A} that are output on the screen 20 for plotting purposes.

Based on FIG. 3 the following paragraphs describe an embodiment of a program that runs on computer 18 and is used for reconstructing the absolute output values A based on the differentiated input values E.

In the first operational step 100 the fading constant τ is determined that represents the fading behavior of the differentiating circuit 14.

This determination of the fading constant τ preferably is carried out in accordance with the subroutine of FIG. 4. In operational step 110 of the subroutine the user first enters the values for the synchronization period duration P of the ADC 16, for the capacity C of the capacitor 34 and for the resistance value R of the resistor 36 of the differentiating circuit 14.

In the following operational step 120 the fading constant τ is calculated by dividing the synchronization period duration P by the product based on capacity C and resistance value R.

In operational step 130 this calculated value for τ is suggested to the user and the user has the ability to accept it in operational step 140 for the subsequent program flow or he can enter a different value.

In operational step 150 the subroutine returns to the main program.

The main program is continued with operational step 200 in which a mean value e is determined based on the input values E entered by the ADC 16.

This mean value e preferably is determined by forming arithmetical mean values from all input values E(n,m) (1≦n≦512, 1≦m≦512).

In the subsequent operational step 300 a first intermediate value Z₁(n,m) is calculated for each scanning point by subtracting the mean value e from the input value E(n,m) in this scanning point. The corresponding equation is as follows

Z₁(n,m)=E(n,m)−e, for 1≦n≦512 and 1≦m≦512.

In operational step 400 a second intermediate value Z₂(1,m) is calculated in each line for the scanning point at the beginning of this line by accepting the first intermediate value Z₁(1,m) in this scanning point as is. The corresponding defining equation is as follows:

Z₂(1,m)=Z₁(1,m),for 1≦m≦512.

In the subsequent operational step 500 a second intermediate value Z₂(n,m) is calculated in each line for the second and each additional scanning point of this line with the calculation being based on the following iteration formula:

Z₂(n,m)=Z₂(n−1,m)+Z₁ (n,m)−Z₁(n−1,m)×exp(−Δn/τ),

for 2≦n≦512 and 1≦m≦512.

In operational step 600 a third intermediate value Z₃(n,1) is calculated for each scanning point of the first line by accepting the second intermediate value Z₂(n,1) in this scanning point as is. The corresponding defining equation is as follows:

Z₃(n,1)=Z₂(n,1),for 1≦n≦512.

In the subsequent operational step 700 the difference D(n,m) between the second intermediate value Z₂(n,m) in this scanning point and the second intermediate value Z₂(n,m−1) for the same scanning point of the previous line is calculated in the second and each additional line for each scanning point of this line. The corresponding defining equation is as follows:

D(n,m)=Z₂(n,m)−Z₂(n,m−1), for 1≦n≦512 and 2≦m≦512.

In the subsequent operational step 800 a mean value d(m) is determined based on the differential values D(n,m) of this line for the second and each subsequent line. Further down different possibilities for determining this mean value d(m) are explained.

In the subsequent operational step 900 the third intermediate value Z₃(n,m) is calculated in the second and each additional line for each scanning point of this line by adding the mean value d(m) of this line to the second intermediate value Z₂(n,m) in this scanning point. The corresponding defining equation is as follows:

Z₃(n,m)=Z₂(n,m)+d(m),for 1≦n≦512 and 2≦m≦512.

In operational step 1000 the minimum M is selected from all third intermediate values Z₃. The corresponding defining equation is as follows

M=min Z₃(n,m).

In the subsequent operational step 1100 the absolute output value A(n,m) for each scanning point is calculated by subtracting the minimum M from the third intermediate value Z₃(n,m) in this scanning point. The corresponding defining equation is as follows:

A(n,m)=Z₃(n,m)−M, for 1≦n≦512 and 1≦m≦512.

In the last operational step 1200 these absolute output values A are put together to make up the image signals B_{A} which then are output on the screen 20 for plotting purposes.

The output values A preferably are presented in the form of a contour line diagram. In this contour line diagram the output values A can be represented by the brightness and/or the color of the corresponding pixels of the screen 20, for example.

The determination of the mean value d(m) for each line based on the differential values D(n,m) of this line that occurred in operational step 800, can simply be carried out by means of arithmetic averaging, for example.

Another possibility is to determine the mean values d(m) by averaging that is weighted based on frequency. For example, it is possible to determine the most frequent differential values for each line based on the differential values D(n,m) and to find the, for example, arithmetical mean value that is used as the mean value d(m) for this line. This is explained in more detail with the help of FIG. 5.

FIG. 5 is a graph in which frequency F of the differential values D(n,m) of this line is entered for a certain exemplary line. In order to be able to determine a meaningful frequency distribution, the abscissa (D axis) is divided into intervals with channel width B within whose limits the individual frequencies F(m,D) are counted. The channel width should be such that the maximum of the F curve that represents the most frequent differential values can be determined with a sufficient degree of accuracy.

Channel width B is determined based on the standard deviation a, i.e. the mean absolute deviation from the arithmetical mean value as well as a factor k that is to be larger than zero but smaller than one. The user can enter the factor as desired in order to influence the channel width B and thus the mean value d(m). This means that the channel width B(m) for each line is calculated based on the following defining equation:

B(m)=σ(m)×k, for 1≦m≦512.

In FIG. 5 the division of the abscissa into intervals with a channel width B is presented by broken, vertical lines. The first interval thus comprises the differential values D(n,m) between 0 and B, the second intervals those between B and 2×B, and each additional interval those between i×B and (i+1)×B with i ≦3.

Then the frequencies F(m,D) of the differential values D(n,m) contained therein are averaged, for example arithmetically, in each interval. The mean values f(m,l) of the individual intervals are shown in FIG. 5 by broken horizontal lines.

Then the maximum is selected from these mean values f(m,i), which, in the example shown in FIG. 5, is the mean value f(m,5) of the fifth interval. This mean value f(m,5) then is used as the mean value d(m) of the line under consideration. The corresponding defining equation for each line is as follows:

d(m)=max f(m,i), for i≦0.

In this embodiment of the determination of the mean values d(m) only those frequencies F(m,D) are used for weighting purposes that belong to the differential values D(n,m) of the interval that has the maximum mean frequency value f(m,i).

However, it also is possible to use not only the interval with the highest mean frequency value f(m,i) (in FIG. 5 i=5) for weighting purposes but also the interval with the next, smaller mean frequency value f(m,i) (in FIG. 5 j=6) or, if desired, additional intervals.

### LIST OF REFERENCE NUMBERS

10 crystal

12 measuring sensor

14 differentiating circuit

16 analog-to-digital converter (ADC)

18 computer

20 screen

22 signal matching circuitry

24 sensor

26 PID controller

28 scan tip

30 actuator

32 current amplifier

34 capacitor

36 resistor

38 potentiometer

40 operational amplifier

42 voltage source

44 first resistor divider

46 second resistor divider

48 interface U_{A} absolute analog measuring signal U_{D} differentiated analog measuring signal U_{V} shifted and amplified analog differentiated measuring signal S_{D} digital differentiated measuring signal E input values (differentiated) A output values (absolute) B_{A} image signal

1. Digital measuring scanner for scanning and plotting the distribution of a measured variable (h) across a scanning pattern (10), in particular digital scanning tunnel microscope comprising:
a sensor (12) for the measured variable (h) that scans the scanning pattern (10) line by line;
a differentiating circuit (14) that is connected to the output of the sensor (12);
an ADC (16) that is connected to the output of the differentiating circuit (14);
a computer (18) for producing image signals (B_{A}) that is connected to the output of the ADC (16) and whose design is such that it can reconstruct absolute output values (A) based on the digital differentiated measuring signal (S_{D}) with the absolute output values corresponding to the values of the measured variable (h) in the scanning points and that produces image signals (B_{A}) based on these values; and
an output device (20) for the image signals (B_{A}) that is connected to the output of the computer (18).

2. Measuring device according to claim 1 wherein the differentiating circuit (14) has a capacitor (34) and a resistor (36).

3. Measuring device according to claim 1 further comprising a circuit (22) for signal matching between the differentiating circuit (14) and the ADC (16) whose design is such that it amplifies the differentiated signal (U_{D}) by a preset factor and increases it by a preset signal level.

4. Measuring device according to claim 1 wherein the computer (18) carries out the following steps for the purpose of reconstructing the absolute output values (A):
calculates a first intermediate value (Z₁(n,m)) for each scanning point by determining a mean value (e) based on the values (E) of the digital, differentiated measuring signal (S_{D}) in the scanning points and by subtracting this mean value (e) from the value (E(n;m)) in this scanning point;
calculates a second intermediate value (Z₂(n,m)) for each scanning point by applying the following formula in each line of the scanning pattern (10) for the scanning point at the beginning of this respective line:
Z₂(1,m)=Z₁ (1,m),
and in that the following iteration formula is applied for each additional scanning point of this line:
Z₂(n,m)=Z₂(n −1,m)+Z₁(n,m)−Z₁(n−1,m)×exp(−Δn/τ),
wherein: m is the index for the lines on the scanning pattern; n is the index for the scanning points in a line, and n=1 represents the beginning of the line; Z₂(n,m) is the second intermediate value to the n-th scanning point in the m-th line; Z₁(n,m) is the first intermediate value to the n-th scanning point in the m-th line; An is the index difference between two adjacent scanning points of a line and Δn=n−(n−1)=1 applies; and τ is a fading constant that represents the fading behavior of the differentiating circuit;
calculates a third intermediate value (Z₃(n,m)) for each scanning point by applying the following formula for the scanning points of the first line of the scanning pattern (10):
Z₃(n,1)=Z₂(n,1),
and initially calculates the difference (D(n,m)) in each additional line for the scanning points of this line based on the following formula:
D(n,m)=Z₂(n,m)−Z₂(n,m−1),
wherein: m is the index for the lines on the scanning pattern and m=1 represents the first line of the scanning pattern; n is the index for the scanning points in one line; Z₂(n,m) is the second intermediate value for the n-th scanning point of the m-th line and D(n,m) is the differential value for the n-th scanning point of the m-th line,
then determines a mean value (d(m)) based on the differential values (D(n,m)) of this line and finally adds this mean value (d(m)) to each second intermediate value (Z₂(n,m)) in the scanning points of this line; and
calculates the absolute output value (A(n,m)) for each scanning point by selecting the minimum from all third intermediate values (Z₃(n,m)) and subtracts this minimum from the third intermediate value (Z₃(n,m)) at this scanning point.

5. Measuring device according to claim 4 wherein the mean value (e) is determined by means of arithmetical averaging based on the values (E) of the digital differentiated measuring signal (S_{D}).

6. Measuring device according to claim 4 wherein the mean value (d(m)) is determined by means of arithmetical averaging based on the differential values (D(n,m)) of a line.

7. Measuring device according to claim 4 wherein the mean value (d(m)) is determined by means of averaging weighted by frequency (F(D)) based on the differential values (D(n,m)) of a line.

8. Measuring device according to claim 4 wherein the fading constant (τ) can be entered into the computer (18).

9. Measuring device according to claim 4 wherein the differentiating circuit (14) has a capacitor (34) and a resistor (36) and in that the computer (18) calculates the fading constant (τ) by dividing the synchronization period duration (P) of the ADC (16) by the capacity (C) of the capacitor (34) and by the resistance value of the resistor (36).

10. Measuring device according to claim 1 wherein the output values (A) are presented as a contour line diagram.

11. Measuring device according to claim 10 wherein the output values (A) are represented by brightness and/or the color of the corresponding pixels in the contour line diagram.
